(19) United States
(12) Patent Application Publication
(10) Pub. No.: US 2018/0001701 A1
(43) Pub. Date: Jan. 4, 2018

(54) DlSK WHEEL AND MANUFACTURING METHOD THEREOF

(71) Applicants: Lei Li, Shanxi (CN); Chundan Li, Shanxi (CN)

(72) Inventors: Lei Li, Shanxi (CN); Chundan Li, Shanxi (CN)

(21) Appl. No.: 15/663,884

(22) Filed: Jul. 31, 2017

Related U.S. Application Data
(63) Continuation of application No. PCT/CN2016/076685, filed on Mar. 18, 2016.

(30) Foreign Application Priority Data
Apr. 24, 2015 (CN) 201510201742.5

(51) Int. Cl. B60B 21/06; B60B 1/02

(52) U.S. Cl. CPC B60B 21/066; B60B 2310/318; B60B 1/0261; B60B 2310/302

(57) ABSTRACT

A disk wheel, comprising a wheel rim (1) and a wheel spoke (2), the inner wall of the wheel rim outer edge (11) is matched with the first wheel spoke convex wall (9), the inner wall of the tire supporting wall (7) is attached to the strengthening wall (8), the groove (5b) is formed in the inner wall of the wheel rim round peak (5), the strengthening wall (8) is provided with the second wheel spoke convex wall (4) in interference fit to the groove (5b), and the groove (5b) is in interference fit to the second wheel spoke convex wall (4), so that the stability of axial matching between the wheel rim (1) and the wheel spoke (2) is guaranteed, and an axial stress, a circumferential stress and a radial stress of the disk wheel in the using process can be effectively addressed.

This application claims priority to Chinese Patent Application No. 201510201742.5 from China Patent Office, titled with “disk wheel and manufacturing method thereof” and filed on Apr. 24, 2015, the entire contents of which are incorporated herein by reference.

### TECHNICAL FIELD

The present invention relates to the technical field of automobile engineering, and more specifically, to a disk wheel and a manufacturing method thereof.

### BACKGROUND OF THE INVENTION

A disk wheel comprises a wheel spoke and a wheel rim. In a using process, the disk wheel may bear loads in three directions, i.e. a first radial load from an automobile body weight, a second circumferential load from automobile body braking and brake and a third axial load from eccentricity of a wheel fixing part and wheel driving in a crooked road, and the three loads are all inconstant fatigue loads. In the prior art, the wheel spoke is welded with an interior of a groove bottom of the wheel rim, the radial load does not have obvious influence on a welding seam between the wheel spoke and the wheel rim, an acting force applied to a connection welding seam by the circumferential load is a shear stress, and the sensitivity of a welding seam defect to the shearing stress is not large. However, an acting force applied to the connection welding seam between the wheel spoke and the wheel rim is a tensile stress. It is known to those skilled in the art that, for the reliability of the resistance to tensile stress, bolt connection and embedding riveting are the best, welding and adhesion are the poorest, and connection defects of welding and adhesion are particularly sensitive to the tensile stress. Although stress concentration and welding defects may be lowered through structural optimization and technical control of a product, an effect is limited to cause a decrease in the service life of the disk wheel.

Thus, how to reduce the influence of the tensile stress on a connecting part between the wheel spoke and the wheel rim so as to prolong the service life of the disk wheel becomes a technical problem to be urgently solved by those skilled in the art.

### SUMMARY OF THE INVENTION

In view of this, the present invention provides a disk wheel to reduce the influence of the tensile stress on the connecting part between the wheel spoke and the wheel rim and prolong the service life of the disk wheel. The present invention also provides a manufacturing method of the disk wheel.

To achieve the above purposes, the present invention provides the following technical solution:

The disk wheel comprises a wheel rim and a wheel spoke. The wheel rim is sequentially provided with a wheel rim outer edge and a tire supporting wall which can be matched with a tire, and a wheel rim round peak from an end part of the wheel rim to a middle part of the wheel rim along an axial direction. A groove is formed in an inner wall of the wheel rim round peak. The wheel spoke is provided with a first wheel spoke convex wall matched with an inner wall of the wheel rim outer edge and a strengthening wall attached to an inner wall of the tire supporting wall, the strengthening wall is provided with a second wheel spoke convex wall in interference fit to the groove, and the wheel rim is connected with the wheel spoke through an adhesive, or the wheel rim is welded with the wheel spoke.

Preferably, in the above disk wheel, a limiting groove in interference fit to the first wheel spoke convex wall for limiting a position of the wheel spoke is formed in the wheel rim outer edge.

Preferably, in the above disk wheel, the wheel spoke is an integrally formed wheel spoke.

Preferably, in the above disk wheel, a spoke of the wheel spoke comprises a spoke convex wall connected with the first wheel spoke convex wall and arranged along a radial direction of the wheel spoke, a spoke strengthening wall connected with the spoke convex wall and concavely extending inwards, and a spoke concave wall connected with the spoke strengthening wall and arranged along the radial direction of the wheel spoke, and the spoke convex wall is arranged on an outer side of the spoke concave wall.

Preferably, in the above disk wheel, a convex wall air hole of the wheel spoke is a closed hole formed by two adjacent spokes, a wheel spoke fixing part of the wheel spoke between the two adjacent spokes and the first wheel spoke convex wall connected with the two adjacent spokes.

Preferably, the above disk wheel further comprises a wheel spoke edge concave wall connected with the spoke concave wall and arranged along a circumferential direction of the edge of the wheel spoke, wherein the wheel spoke edge concave wall is connected with the strengthening wall.

Preferably, in the above disk wheel, a concave wall air hole of the wheel spoke is a closed hole formed by two adjacent spokes, the wheel spoke fixing part between the two adjacent spokes and the wheel spoke edge concave wall connected with the two adjacent spokes.

Preferably, in the above disk wheel, the groove is a trapezoid groove, and a groove wall arranged on the trapezoid groove along the radial direction of the wheel rim is attached to the wheel spoke edge concave wall.

A manufacturing method of the disk wheel comprises the following steps:

step 1), manufacturing the wheel rim, wherein the groove is formed in the inner wall of the wheel rim round peak of the wheel rim;

step 2), manufacturing the wheel spoke, wherein the first wheel spoke convex wall, the strengthening wall, and the wheel spoke edge concave wall of the wheel spoke are adhesively attached to an inner wall of the wheel rim outer edge, the inner wall of the tire supporting wall and a groove wall respectively, and the wheel rim outer edge, the tire supporting wall and the groove wall after adhesion enter an expanding riveting die concave cavity;

step 3), forming a second wheel spoke convex wall by expanding the inner wall of the strengthening wall of the wheel spoke through the expanding riveting die, wherein the second wheel spoke convex wall is in interference fit to the groove; and

step 4), manufacturing the limiting groove in the wheel rim outer edge of the wheel rim through a bending technology, wherein the limiting groove is in interference fit to the first wheel spoke convex wall.

Preferably, in the above manufacturing method of the disk wheel, the groove is a trapezoid groove.

Seen from the above technical solution, a mode of direct welding between the wheel rim and the wheel spoke in the prior art is replaced by a connection mode with combination of interference fit and adhesion between the wheel rim groove and the wheel spoke or a connection mode with combination of interference fit and welding between the wheel rim groove and the wheel spoke in the disk wheel provided by the present invention. Interference fit can effectively disperse circumferential stress concentration of the spoke of the wheel spoke, and improve the capability of the disk wheel for resisting a circumferential stress, so as to effectively prolong the service life of the disk wheel. In a device provided by the present invention, the inner wall of the wheel rim outer edge is matched with the first wheel spoke convex wall, the inner wall of the tire supporting wall is attached to the strengthening wall, the groove is formed in the inner wall of the wheel rim round peak, the strengthening wall is provided with the second wheel spoke convex wall in interference fit to the groove, and the groove is in interference fit to the second wheel spoke convex wall, so that the stability of axial matching between the wheel rim and the wheel spoke is guaranteed, and an axial stress, a circumferential stress and a radial stress of the disk wheel in the using process can be effectively addressed.

### BRIEF DESCRIPTION OF THE DRAWINGS

In order to explain embodiments of the present invention or the technical solution in the prior art more clearly, drawings to be used in the description of the embodiments or the prior art will be simply described below. Apparently, the drawings described below are some embodiments of the present invention merely. Other drawings may also be obtained according to these drawings without contributing any creative work for those ordinary skilled in the art.

FIG. 1 is a structural schematic diagram of a disk wheel provided by an embodiment of the present invention;

FIG. 2 is a section view of I-I in FIG. 1 provided by an embodiment of the present invention;

FIG. 3 is a partially enlarged diagram at A in FIG. 2 provided by an embodiment of the present invention;

FIG. 4 is a partially enlarged diagram at B in FIG. 2 provided by an embodiment of the present invention;

FIG. 5 is a structural schematic diagram of a wheel spoke of a disk wheel provided by an embodiment of the present invention.

1. wheel rim, 2. wheel spoke, 3. wheel spoke edge concave wall, 3a. spoke concave wall, 4. second wheel spoke convex wall, 5. wheel rim round peak, 5b. groove, 6. end edge groove wall, 7. tire supporting wall, 8. strengthening wall, 8a. spoke strengthening wall, 9. first wheel spoke convex wall, 9a. spoke convex wall, 10. edge end surface, 11. wheel rim outer edge, 12. limiting groove, 13. wheel spoke fixing part, 14. first inflection point, 15. second inflection point, 16b. groove wall, 17. welding seam, 18. concave wall air hole, and 19. convex wall air hole.

### DETAILED DESCRIPTION OF THE INVENTION

The present invention discloses a disk wheel to reduce an influence of a tensile stress on a connecting part between a wheel spoke and a wheel rim and prolong the service life of the disk wheel. The present invention also discloses a manufacturing method of the disk wheel.

The technical solutions in the embodiments of the present invention will be described below clearly and completely with combination of the drawings in the embodiments of the present invention. Apparently, the described embodiments are only some embodiments of the present invention, not all the embodiments of the present invention. All other embodiments obtained by those ordinary skilled in the art based on the embodiments of the present invention without contributing creative work shall fall within the protection scope of the present invention.

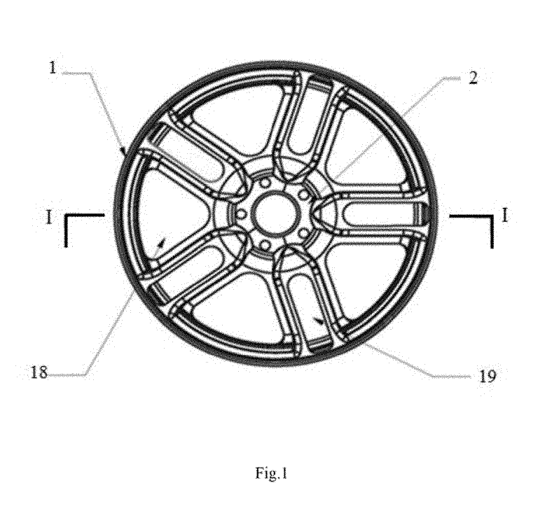

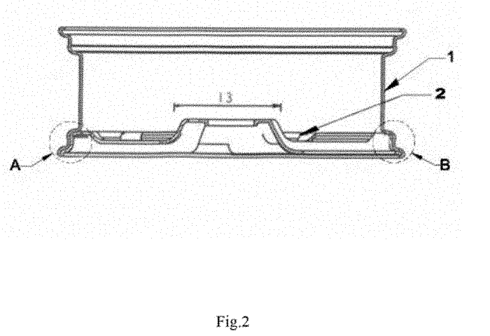

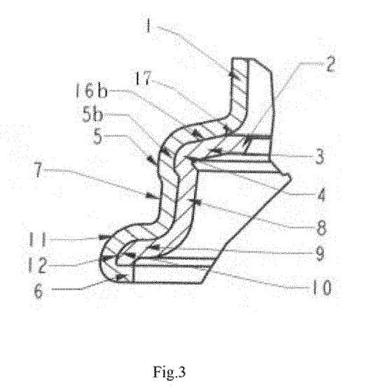

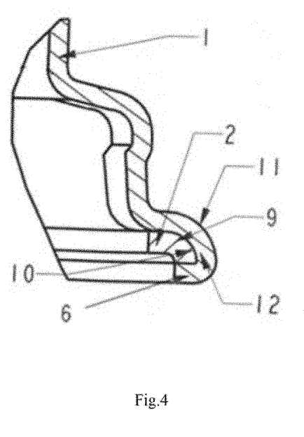

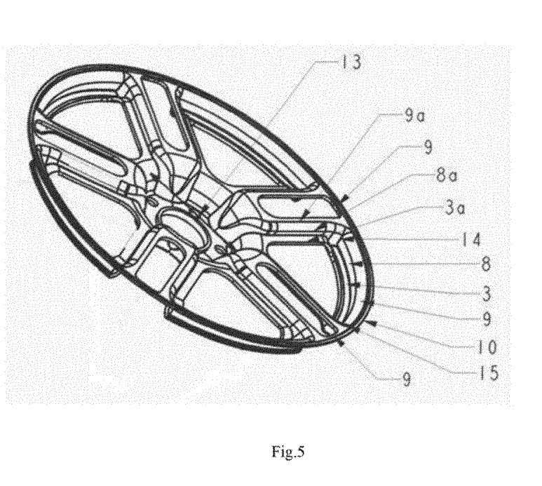

Referring to FIGS. 1 to 5, FIG. 1 is a structural schematic diagram of the disk wheel provided by the embodiment of the present invention; FIG. 2 is a section view of I-I in FIG. 1 provided by the embodiment of the present invention; FIG. 3 is a partially enlarged diagram at A in FIG. 2 provided by the embodiment of the present invention; FIG. 4 is a partially enlarged diagram at B in FIG. 2 provided by the embodiment of the present invention; and FIG. 5 is a structural schematic diagram of the wheel spoke of the disk wheel provided by the embodiment of the present invention.

The present invention discloses a disk wheel which comprises a wheel rim 1 and a wheel spoke 2, wherein the wheel rim 1 is sequentially provided with a wheel rim outer edge 11, a tire supporting wall 7 which can be matched with a tire and a wheel rim round peak 5 from an end part of the wheel rim 1 to a middle part of the wheel rim 1 along an axial direction. A groove 5b is formed in the inner wall of the wheel rim round peak 5. The wheel spoke 2 is provided with a first wheel spoke convex wall 9 matched with an inner wall of the wheel rim outer edge 11 and a strengthening wall 8 attached to an inner wall of the tire supporting wall 7. The strengthening wall 8 is provided with a second wheel spoke convex wall 4 in interference fit to the groove 5b, and the wheel rim 1 is connected with the wheel spoke 2 through an adhesive.

In the solution, the wheel rim 1 is connected with the wheel spoke 2 through the adhesive. For a connection mode with combination of interference fit and adhesion, the consistency of product production is good and checking cost of product production can be reduced to a certain extent relative to welding connection. For the connection mode with combination of interference fit and adhesion, combination time of the wheel rim 1 and the wheel spoke 2 can be shortened, and thus the production efficiency of a product may be increased relative to welding. For the connection mode with combination of interference fit and adhesion, deformation of the wheel rim 1 and the wheel spoke 2 caused by welding may be effectively avoided relative to welding connection. The smaller a deformation quantity of a steel material is, the higher the strength is. Therefore, the using strength of the wheel rim 1 and the wheel spoke 2 may be improved to a certain degree, a plate with higher strength may be selected in a practical production process, and the service life of the disk wheel is guaranteed.

Adhesive connection of the wheel rim 1 and the wheel spoke 2 further ensures the stability of matching of the wheel rim 1 and the wheel spoke 2. Since a braking moment or a brake moment of an automobile are transferred to the wheel spoke 2 through a wheel flange firstly, then transferred to the wheel rim 1 through the wheel spoke 2 and transferred to the ground by the wheel rim 1 through a tire finally, the wheel rim 1 is matched with the wheel spoke 2 in a mode of interference fit and adhesive fit, causing that the capability of the wheel spoke 2 and the wheel rim 1 of resisting the shear force circumferentially is larger than a friction force between the tire and the ground and larger than a friction force between the tire and the wheel rim 1, and the stability of connection between the wheel rim 1 and the wheel spoke 2 is further guaranteed.

Axial constraint of the wheel rim 1 and the wheel spoke 2 adopts rigid connection of interference fit of the limiting groove 12 and the first wheel spoke convex wall 9 and interference fit of the groove 5b and the second wheel spoke convex wall 4, circumferential constraint of the wheel rim 1 and the wheel spoke 2 adopts adhesive rigid connection, and radial constraint of the wheel rim 1 and the wheel spoke 2 is realized jointly by interference embedding rigid connection and adhesive connection.

Production of the wheel rim 1 adopts a traditional three-rolling formation technology and follows a standard on a wheel rim of GB/T3487-2005 or ISO4000-2:2001 in the manufacturing process. The production process comprises the following steps: step 1, manufacturing the acceptable wheel rim 1 according to the standard, wherein the groove 5b is formed in the inner wall of the wheel rim round peak 5 of the wheel rim 1; step 2, manufacturing the acceptable wheel spoke 2, and combining the wheel rim 1 and the wheel spoke 2, wherein the first wheel spoke convex wall 9 of the wheel spoke 2 is adhesively attached to an inner wall of the wheel rim outer edge 11, the strengthening wall 8 is adhesively attached to the inner wall of the tire supporting wall 7, and a wheel spoke edge concave wall is adhesively attached to a groove wall 16b; and step 3, expanding the strengthening wall 8 through the expanding riveting die, and forming the second wheel spoke convex wall 4 on the strengthening wall, wherein the second wheel spoke convex wall 4 is in interference fit to the groove 5b.

After the second wheel spoke convex wall 4 is in interference fit to the groove 5b, interference fit of the wheel rim 1 and the wheel spoke 2 is realized firstly; and in order to further improve the capability of a connecting part between the wheel rim 1 and the wheel spoke 2 for resisting the axial tensile stress, the limiting groove 12 in interference fit to the first wheel spoke convex wall 9 for limiting the position of the wheel spoke 2 is formed in the wheel rim outer edge 11 and is manufactured through the bending technology.

The production process of the disk wheel further comprises a fourth step of bending the end edge groove wall 6 of the wheel rim outer edge 11 through the bending technology, and manufacturing the limiting groove 12.

The edge end surface 10 of the first wheel spoke convex wall 9 is matched with the end edge groove wall 6 after being bended, and the limiting groove 12 is in interference fit to the first wheel spoke convex wall 9, thereby further guaranteeing the axial limiting action of the wheel rim 1 on the wheel spoke 2.

In order to further optimize the above technical solution, in a specific embodiment of present invention, the wheel spoke 2 is an integrally formed wheel spoke. Integral forming can ensure the integral strength of the wheel spoke 2, and an integral forming technology is convenient in manufacturing, so that the production efficiency of the wheel spoke 2 is improved to a certain extent.

There are a lot of selections of materials of the wheel rim 1 and the wheel spoke 2. Preferably, in the solution, the wheel rim 1 and the wheel spoke 2 are manufactured by steel plates, and the steel plates are high in using strength and may meet the strength requirements of the disk wheel. In addition, the wheel rim 1 and the wheel spoke 2 can also be made of aluminium alloy, and the aluminium alloy may ensure the using strength of the disk wheel and may also reduce the weight of the disk wheel at the same time.

As shown in FIG. 5, a spoke of the wheel spoke 2 comprises a spoke convex wall 9a connected with the first wheel spoke convex wall 9 and arranged along a radial direction of the wheel spoke 2, a spoke strengthening wall 8a connected with the spoke convex wall 9a and concavely extending inwards, and a spoke concave wall 3a connected with the spoke strengthening wall 8a and arranged along the radial direction of the wheel spoke 2, and the spoke convex wall 9a is positioned on an outer side of the spoke concave wall 3a. For the spoke designed in the solution, the capability of the spoke for bearing force may be strengthened, and the spoke is in a step shape integrally. In addition, the spoke convex wall 9 is arranged on the outer side of the spoke concave wall 3a. A definition of the outer side herein takes an automobile body as a reference. One side close to the middle of the automobile body is an inner side, and one side far away from the automobile body is an outer side.

For further ensuring the using strength of the wheel spoke 2, the disk wheel further comprises a wheel spoke edge concave wall 3 connected with the wheel spoke concave wall 3a and arranged along a circumferential direction of the wheel spoke 2, wherein the wheel spoke edge concave wall 3 is connected with the strengthening wall 8, and design of the wheel spoke edge concave wall 3 has the action of reinforcing the first wheel spoke convex wall 9 and the spoke so as to further improve the capability of the spoke 2 for bearing an external force.

For lightening the mass of the disk wheel, air holes in various forms are formed in the wheel spoke 2, and may be strip-shaped air holes, may be fan-shaped air holes or may be air holes in other forms. In the solution, two forms of the air holes are provided:

A convex wall air hole 19 is a closed hole formed by two adjacent spokes, a wheel spoke fixing part 13 of the wheel spoke 2 between the two adjacent spokes and the first wheel spoke convex wall 9 connected with the two adjacent spokes, i.e., the strip-shaped air hole shown in FIG. 5; and

a concave wall air hole 18 is a closed hole formed by two adjacent spokes, the wheel spoke fixing part 13 between the two adjacent spokes and the wheel spoke edge concave wall 3 connected with the two adjacent spokes, i.e., the fan-shaped air hole shown in FIG. 5.

The convex wall air hole 19 and the concave wall air hole 18 may be in a fan shape and may be in a strip shape, but are not limited to these two shapes. In addition, it should be noted that the convex wall air hole 19 is formed in the outer side of the wheel spoke 2, the concave wall air hole 18 is formed in the inner side of the wheel spoke 2, and definitions of the inner side and the outer side herein take the automobile body as the reference, wherein one side close to the middle of the automobile body is the inner side, and one side far away from the automobile body is the outer side.

In addition, two inflection points, i.e. a first inflection point 14 and a second inflection point 15 in FIG. 5, may be formed at the connecting parts with the spoke concave wall 3a in two ends of the wheel spoke edge concave wall 3 in the air hole 18, and the shape of the air hole 18 may be changed by changing positions of the first inflection point 14 and the second inflection point 15.

With arrangement of the convex wall air hole 19 and the concave wall air hole 18, not only the mass of the disk wheel is lightened, but also the heat dissipation capability of the disk wheel is strengthened, so that a larger space is reserved for an automobile brake system, and a feeling of larger size in appearance may be provided to people.

In order to further optimize the above technical solution, in one specific embodiment of the present invention, the groove 5b is a trapezoid groove. FIG. 3 and FIG. 4 illustrate sectional views of the wheel rim 1 along the axial direction. The structure of the trapezoid groove is shown in the drawings. A groove wall 16b arranged on the trapezoid groove along the radial direction of the wheel rim 1 is attached to the wheel spoke edge concave wall 3. A groove wall of the trapezoid groove opposite to the groove wall 16b and an upper bottom surface of the trapezoid groove are matched with the second wheel spoke convex wall 4. The trapezoid groove is in interference fit to the second wheel spoke convex wall 4, the groove wall 16b has the limiting action on movement of the wheel spoke 2, and the stability of matching of the wheel rim 1 and the wheel spoke 2 is further improved with combination of interference fit and the limiting action herein. The groove 5b is not limited to the above shapes and may also be a circular arc groove. One end of a groove wall of the circular arc groove is matched with the second wheel spoke convex wall 4, and the other end is attached to the wheel spoke edge concave wall 3. Certainly, the groove 5b may also be in other shapes for achieving the solution.

The wheel rim 1 and the wheel spoke 2 may also adopt a mode with combination of interference fit and welding. As shown in FIG. 3, 17 in FIG. 3 represents a welding seam.

A manufacturing method of the disk wheel comprises the following steps:

step 1), manufacturing the wheel rim 1, wherein the groove 5b is formed in an inner wall of the wheel rim round peak 5 of the wheel rim 1;

step 2), manufacturing the wheel spoke 2, wherein the first wheel spoke convex wall 9, the strengthening wall 8 and the wheel spoke edge concave wall 3 of the wheel spoke 2 are adhesively attached to an inner wall of the wheel rim outer edge 11, the inner wall of the tire supporting wall 7 and the groove wall 16b respectively, and the wheel rim outer edge 11, the tire supporting wall 7 and the groove wall 16b after adhesion enter an expanding riveting die concave cavity;

step 3), forming a second wheel spoke convex wall 4 by expanding the inner wall of the strengthening wall 8 of the wheel spoke 2 through the expanding riveting die, wherein the second wheel spoke convex wall 4 is in interference fit to the groove 5b; and

step 4), manufacturing the limiting groove 12 in an end edge groove wall 6 of the wheel rim outer edge 11 of the wheel rim 1 through the bending technology, wherein the limiting groove 12 is in interference fit to the first wheel spoke convex wall 9.

First-step interference fit of the wheel rim 1 and the wheel spoke 2 is realized through matching of the second wheel spoke convex wall 4 and the groove 5b; second-step interference fit of the wheel rim 1 and the wheel spoke 2 is realized through matching of the limiting groove 12 and the first wheel spoke convex wall 9; and stable connection of the wheel rim 1 and the wheel spoke 2 is realized by the above two steps of interference fit. The interference fit can effectively disperse the axial stress of the spoke to the wheel rim 1, relieve stress concentration and improve the capability of the connecting part between the wheel rim 1 and the wheel spoke 2 for resisting the tensile stress.

Axial constraint of the wheel rim 1 and the wheel spoke 2 adopts rigid connection in a mode of interference fit; circumferential constraint of the wheel rim 1 and the wheel spoke 2 adopts adhesive rigid connection; and radial constraint of the wheel rim 1 and the wheel spoke 2 is realized jointly by interference embedding rigid connection and adhesive connection.

Compared with a welding mode in the prior art, a mode of interference fit and adhesive connection in the method can reduce the checking cost of product production to a certain extent, and increase the production efficiency of a product at the same time. The mode of interference fit and adhesive connection can reduce deformation of the wheel rim 1 and the wheel spoke 2 relative to the welding connection. Since deformation of the steel material is in inverse proportion to the strength and deformation of the wheel rim 1 and the wheel spoke 2 is small, the using strength of the wheel rim 1 and the wheel spoke 2 can be guaranteed. A plate with higher strength can also be selected in the practical production process, so as to guarantee the service life of the disk wheel.

In order to further optimize the above technical solution, in one specific embodiment of the present invention, the groove 5b is a trapezoid groove. FIG. 3 and FIG. 4 illustrate sectional views of the wheel rim 1 along the axial direction. The structure of the trapezoid groove is shown in the drawings. The groove wall 16b arranged on the trapezoid groove along the radial direction of the wheel rim 1 is attached to the wheel spoke edge concave wall 3. The groove wall of the trapezoid groove opposite to the groove wall 16b and the upper bottom surface of the trapezoid groove are matched with the second wheel spoke convex wall 4. The trapezoid groove is in interference fit to the second wheel spoke convex wall 4. The groove wall 16b has the limiting action on movement of the wheel spoke 2. The stability of matching of the wheel rim 1 and the wheel spoke 2 is further improved with combination of interference fit and the limiting action herein. The groove 5b is not limited to the above shapes and may also be the circular arc groove. One end of the groove wall of the circular arc groove is matched with the second wheel spoke convex wall 4, and the other end is attached to the wheel spoke edge concave wall 3. Certainly, the groove 5b may also be in other shape for realizing the solution.

The wheel rim 1 and the wheel spoke 2 may also adopt a mode with combination of interference fit and welding. As shown in FIG. 3, 17 in FIG. 3 represents the welding seam.

The previous description of the disclosed embodiments enables those skilled in the art to achieve or use the present invention. Multiple amendments to these embodiments are apparent to those skilled in the art. General principles defined in this application may be achieved in the other embodiments without departing from the spirit or scope of the present invention. Thus, the present invention will not be limited to these embodiments shown in this application, but shall accord with the widest scope consistent with the principles and novel characteristics disclosed by this application.

What is claimed is:

1. A disk wheel, comprising:
a wheel rim (1) and a wheel spoke (2);
wherein the wheel rim (1) is sequentially provided with a wheel rim outer edge (11) and a tire supporting wall (7) which can be matched with a tire from an end part of the wheel rim (1) to a middle part of the wheel rim (1) along an axial direction, and the wheel spoke (2) is provided with a first wheel spoke convex wall (9) matched with an inner wall of the wheel rim outer edge (11) and a strengthening wall (8) attached to an inner wall of the tire supporting wall (7);
a limiting groove (12) which is in interference fit to the first wheel spoke convex wall (9) for limiting a position of the wheel spoke (2) is provided in the wheel rim outer edge (11), and the wheel rim (1) is connected with the wheel spoke (2) through an adhesive, or the strengthening wall (8) is welded with the tire supporting wall (7).

2. The disk wheel according to claim 1, wherein a spoke of the wheel spoke (2) comprises a spoke convex wall (9a) connected with the first wheel spoke convex wall (9) and arranged along a radial direction of the wheel spoke (2), a spoke strengthening wall (8a) connected with the spoke convex wall (9a) and concavely extending inwards, and a spoke concave wall (3a) connected with the spoke strengthening wall (8a) and arranged along the radial direction of the wheel spoke (2), and the spoke convex wall (9a) is arranged on an outer side of the spoke concave wall (3a).

3. The disk wheel according to claim 2, wherein the wheel rim (1) is further provided with a wheel rim round peak (5) in an axial direction; a groove (5b) is formed in an inner wall of the wheel rim round peak (5); the strengthening wall (8) is provided with a second wheel spoke convex wall (4) in interference fit to the groove (5b) and for expanding the strengthening wall (8) by an expanding riveting die; and the second wheel spoke convex wall (4) is formed on the strengthening wall (8).

4. The disk wheel according to claim 1, wherein the wheel spoke (2) is an integrally formed wheel spoke.

5. The disk wheel according to claim 1, wherein a convex wall air hole (19) of the wheel spoke (2) is a closed hole formed by two adjacent spokes, a wheel spoke fixing part (13) of the wheel spoke (2) between the two adjacent spokes and the first wheel spoke convex wall (9) connected with the two adjacent spokes.

6. The disk wheel according to claim 3, further comprising a wheel spoke edge concave wall (3) connected with the wheel spoke concave wall (3a) and arranged along a circumferential direction of the edge of the wheel spoke (2); wherein the wheel spoke edge concave wall (3) is connected with the strengthening wall (8).

7. The disk wheel according to claim 6, wherein a concave wall air hole (18) of the wheel spoke (2) is a closed hole formed by two adjacent spokes, the wheel spoke fixing part (13) between the two adjacent spokes and the wheel spoke edge concave wall (3) connected with the two adjacent spokes.

8. The disk wheel according to claim 6, wherein the groove (5b) is a trapezoid groove, and a groove wall (16b) arranged on the trapezoid groove along the radial direction of the wheel rim (1) is attached to the wheel spoke edge concave wall (3).

9. A manufacturing method of a disk wheel, comprising the following steps:
a, manufacturing a wheel rim (1);
b, manufacturing a wheel spoke (2); wherein a first wheel spoke convex wall (9) and a strengthening wall (8) of the wheel spoke (2) are attached to an inner wall of the wheel rim outer edge (11) and the inner wall of the tire supporting wall (7) in an adhesive fit manner respectively, or the strengthening wall (8) is welded with the tire supporting wall (7), and the wheel rim outer edge (11) and the tire supporting wall (7) after adhesion/welding enter an expanding riveting die concave cavity; and
c, manufacturing the limiting groove (12) in an end edge groove wall (6) of the wheel rim outer edge (11) of the wheel rim (1) through a bending technology, wherein the limiting groove (12) is in interference fit to the first wheel spoke convex wall (9).

10. The manufacturing method of the disk wheel according to claim 9, wherein the a further comprises a step of forming the groove (5b) in the inner wall of the wheel rim round peak (5) of the wheel rim (1), wherein the groove (5b) is a trapezoid groove.

11. The manufacturing method of the disk wheel according to claim 9, further comprising a step of forming the second wheel spoke convex wall (4) by expanding the inner wall of the strengthening wall (8) of the wheel spoke (2) by the expanding riveting die, wherein the second wheel spoke convex wall (4) is in interference fit to the groove (5b).
